(19) United States
(12) Patent Application Publication
(10) Pub. No.: US 2002/0145357 A1
(43) Pub. Date: Oct. 10, 2002

(54) Rotor bar and rotor lamination

(76) Inventors: Yue Li, Baldwinsville, NY (US); Wen Yang, Maryland Hts, MO (US); Richard Belley, St. Louis, MO (US)

Correspondence Address: Mark L. Gleason, Howrey Simon Arnold & White, LLP, 750 Bering Drive, Houston, TX, 77057-2198, US

(21) Appl. No.: 09/832,359

(22) Filed: Apr. 10, 2001

(51) Int. Cl. H02K 3/04

(52) U.S. Cl. 310/201

(57) ABSTRACT

A rotor bar cross-section and a rotor lamination slot define an asymmetrical shape divided into first and second sides about a longitudinally extending centerline, with the first and second sides being asymmetrical relative to the centerline. The first longitudinal side has upper and lower portions connected by a middle portion. The upper, middle and lower portions each include a respective point on the outer periphery of the bar located farthest from the centerline. These respective points define first, second and third distances between the respective points and the centerline, with the second distance being less than either of the first and third distances. The second longitudinal side has an upper portion directly connected to a lower portion. In certain embodiments, pairs of slots are arranged “face to face” to maintain the symmetry of the rotor lamination, even though the slots or bars themselves are asymmetrical. This improves manufacturability by allowing the use of traditional rotor construction methods for symmetrical rotor slots.

### BACKGROUND OF THE INVENTION

1. Field of the Invention

The invention relates generally to squirrel cage rotors, and more particularly, to an improved rotor bar shape for a squirrel cage rotor.

2. Description of the Related Art

Induction motors are popular for several reasons, including high robustness, reliability, low price and high efficiency. A typical induction motor includes a stationary member, or stator, that has a plurality of windings disposed therein. A rotating member, or rotor, is situated within the stator to rotate relative thereto. In a three-phase induction motor, for example, a rotating magnetic field is established by applying three-phase sinusoidal alternating current to the stator windings. The rotating magnetic field interacts with the rotor windings to effect rotation of the rotor.

A popular induction motor rotor construction is the “squirrel cage” or simply “cage” rotor, in which the rotor windings comprise a plurality of bars that extend through the rotor core essentially parallel to the rotor shaft. The bars are made of a conductive material such as aluminum, copper or brass. The rotor core typically consists of several laminations stacked together and pressed against the rotor shaft, with each lamination having closed slots through which the bars extend. The bars protrude beyond the rotor core and are connected together by a shorting ring at each end, such that the bars connected by the end rings resemble a cage used to exercise squirrels or other such animals.

The performance of an induction motor is largely determined by the design of the rotor, and more specifically, the bar design in a cage rotor. During normal operation, the resistance of the rotor bars should be minimal. However, this low resistance results in low starting torque and high starting current. Thus problem has been addressed by providing essentially two sets of rotor bars—a “double cage,” wherein one set of rotor bars is of high resistance and low reactance and the other is of low resistance and high reactance. Thus, when the machine is starting, the high resistance bars carry the greater part of the load, and when the machine is up to speed, the low resistance bars carries the load.

The two sets of rotor bars actually comprise one bar structure that is divided into two parts connected by a thin neck portion. FIGS. 1A and 1B illustrate cross-sections of a typical rotor bars 10a, 10b for a double cage rotor. The rotor bars 10a, 10b present a symmetrical shape about a centerline 11. The upper portion 12 (the part of rotor bar closer to the outside of the rotor) has a small cross-sectional area as compared to the lower portion 14 (the part closer to the rotor shaft). The upper portion 12 and lower portion 14 are connected by a thin neck portion 16.

In certain machine constructions, typically small size motors, the rotor laminations are assembled face-to-face with the slots aligned, and the rotor bars are “cast-in-place” by pouring molten conductive material, such as aluminum, into the openings formed by the slots in the stacked laminations. In other machine constructions, especially larger size machines, the rotor bars may be preformed by any suitable process such as extrusion or casting and inserted into the openings formed by the slots of the stacked rotor laminations.

Double-cage designs provide desirable high starting torque and low starting current, but are associated with manufacturability reliability problems. Due to the shape of the double bar 10, particularly the small upper portion 12 and thin neck portion 16, double bar designs are difficult to die cast, especially when a high number of rotor bars are used. The rotor bars of single-cage rotor constructions do not include the small head portion or thin neck and thus are more easily manufactured. Further, generally speaking, the cross sectional area of a double cage bar is smaller than that of a single bar, so the motors with double cage bars usually have lower efficiency than the motors with single bar due to relatively higher rotor resistance. Unfortunately, single cage designs do not provide the starting performance of double-cage designs.

Thus, a need exists for a rotor construction that addresses shortcomings of the prior art.

### SUMMARY OF THE INVENTION

As discussed above, a double cage design provides high starting torque and low starting current, which is desirable in many applications. A rotor bar for a single cage design is more easily manufactured and generally produces more efficient motors, but fails to provide the starting performance of a double cage design. The present invention provides a bar shape that offers positive features of both single and double-cage designs.

The present invention provides a rotor bar and rotor lamination slot shape that improves motor performances—both starting and rated operation. Starting current may be reduced while maintaining the necessary starting torque. Or, the starting torque may be increased while keeping the starting current unchanged. This results in a higher torque per amps value. Further, the rotor bars and slots of the present invention generally have a larger area than that of double cage bars to increase efficiency.

In one aspect of the present invention, a rotor bar cross section or a corresponding rotor lamination slot define an asymmetrical shape divided into first and second sides about a longitudinally extending centerline. The first longitudinal side has upper and lower portions connected by a middle, or neck, portion. Each of the upper, middle and lower portions have a respective point on the outer periphery of the bar located farthest from the centerline that defines first, second and third distances between the respective points and the centerline. The second distance is less than either the first or third distances. The second longitudinal side has an upper portion directly connected to a lower portion. In certain embodiments, the combined lower portion is generally symmetrical about the centerline, while the combined upper and middle portions are asymmetrical about the centerline.

In other aspects of the invention, a rotor lamination defines a plurality of asymmetrical slots as described herein The slots are oriented in alternating directions such that each pair of slots are symmetrical. This maintains the “symmetry” of the lamination disk, even though the slots themselves are asymmetrically shaped, allowing use of traditional manufacturing methods for symmetric rotor construction.

### BRIEF DESCRIPTION OF THE DRAWINGS

Other objects and advantages of the invention will become apparent upon reading the following detailed description and upon reference to the drawings in which:

FIGS. 1A and 1B are cross-section views of prior art double cage rotor bars;

FIG. 2 illustrates a cross-sectional shape of a rotor bar in accordance with an embodiment of the present invention;

FIG. 3 illustrates a cross-sectional shape of a rotor bar in accordance with another embodiment of the present invention;

FIG. 4 illustrates a rotor lamination in accordance with an embodiment of the present invention;

FIGS. 5A and 5B illustrate radial and parallel arrangements of pairs of rotor slots situated in opposing directions; and

FIG. 6 illustrates a rotor lamination in accordance with another embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

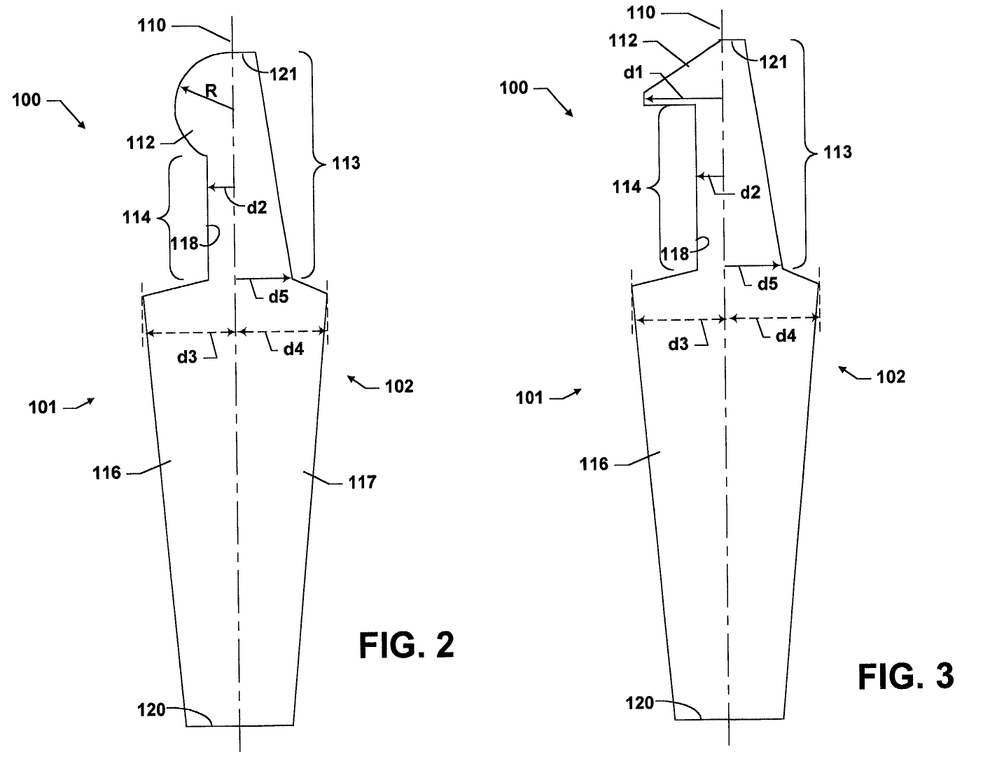

FIG. 2 and FIG. 3 are cross-section views of exemplary rotor bars 100A, 100B in accordance with aspects of the present invention. The shapes of the rotor bars 100A, 100B shown in FIGS. 2 and 3 also represent the shape of the corresponding slots in a rotor lamination through which the rotor bar 100A, 100B would extend. Due to the bird-like form of the rotor bar cross sections shown in FIGS. 2 and 3, the rotor bar 100A, 100B is sometimes referred to as the “eagle” or “bird” bar or slot in this specification.

In certain machine constructions, typically small size motors, the rotor laminations are assembled face-to-face with the slots aligned, and the rotor bars are “cast-in-place” by pouring molten conductive material, such as aluminum, into the openings formed by the slots in the stacked laminations. In other machine constructions, especially larger size machines, the rotor bars may be preformed by any suitable process such as extrusion or casting and inserted into the openings of the stacked rotor laminations. The present invention is applicable to either type of rotor bar construction.

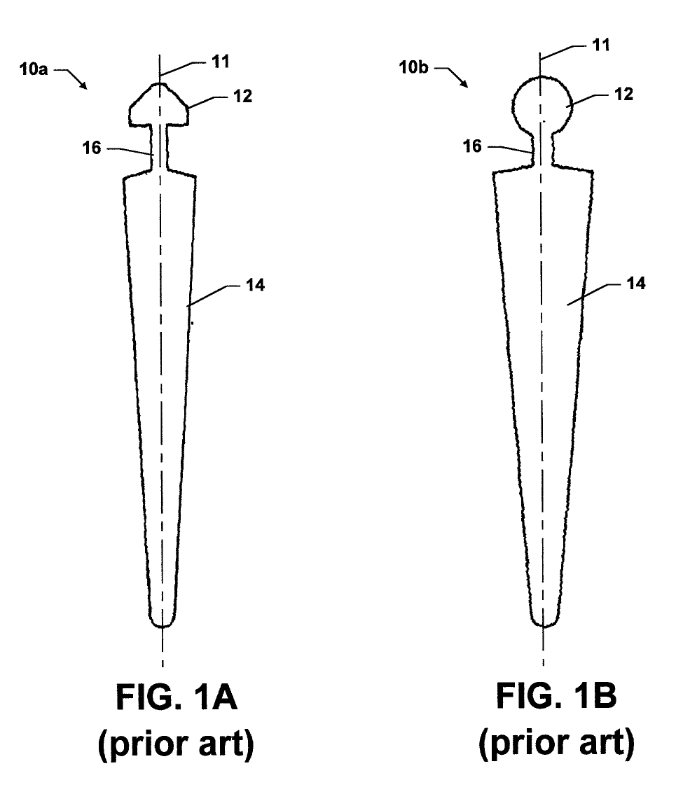

The rotor bar 100A, 100B is suitable for a cage rotor used, for example, in an AC induction motor. For simplicity, the term “motor” is used throughout this specification. However, one skilled in the art having the benefit of this disclosure wil understand that the present invention is applicable to any type of rotating electric machine, including motors and generators. The rotor bar 100A, 100B is divided into two sides by a longitudinal centerline 110. The centerline 110 typically extends radially from the rotor shaft (not shown in FIGS. 2 and 3). Known rotor bars are typically symmetrical about such a centerline, as is the prior art double cage rotor bar 10 shown in FIG. 1. In accordance with the present invention, however, the rotor bar 100A, 100B defines a non-symmetrical shape. Thus, the term “centerline” as used with reference with the bar shapes of the present invention may not refer to a centerline in the conventional sense—the line 110 may not actually divide the rotor bar 100A, 100B into two halves having equal mass or cross sectional area. Rather, the centerline 110 provides a reference for defining the respective shapes of the longitudinal sides of the rotor bar 100A, 100B on either side of the centerline 110.

The exemplary rotor bar 100 is divided into first and second sides 101, 102 on opposite sides of the centerline 110. As viewed in FIG. 2, the first side 101 is left of the centerline 110 and the second side is right of the centerline 110. The first side 101 of the rotor bar 100 defines a shape similar to a standard double bar for a double cage rotor, with an upper portion 112 and a middle, or neck, portion 114 connecting the upper portion 112 to a lower portion 116. The relative terms “upper” and “lower” or “top” and “bottom” are used in this specification in regard to the rotor bar to designate the portions closest and farthest from the outer periphery of the rotor, respectively. In other words, the “top” portion of the rotor bar or lamination slot in which a rotor bar is disposed refers to the portion farthest from the center of the lamination and closest to the machine air gap. As viewed in FIG. 2, the upper portion 112 is nearer the top of the page and the lower portion 116 is nearer the bottom of the page.

The upper, neck and lower portions 112, 114, 116 each have a respective point on the outer periphery of the bar 100A, 100B that is located farthest from the centerline. These points define first, second and third distances, respectively, between the centerline 110 and the outer periphery of the bar 100A, 100B. As shown in FIG. 2, the first distance is the radius R of the curved upper portion 114. In the bar 100B shown in FIG. 2, the first distance is d1. The second and third distances are represented by references d2 and d3, respectively. Since the first side 101 of the bar 100A, 100B, is similar to a standard double-cage rotor bar, the second distance d2 is less than either of the first distance R/d1 and the third distance d3.

In contrast, the second side 102 does not include a separate upper portion that is connected to the lower portion 117 by a thin neck, as does the first side 101 and the prior art double bar 10 shown in FIG. 1. Rather, the second side 102 has an upper portion 113 that is directly connected to the lower portion 117. The upper portion 113 tapers from a top edge 121 gradually away from the centerline 110 towards the lower portion 117. From the bottom edge 120, the lower portion 117 of the second side 102 tapers gradually away from the centerline 110 towards the top of the rotor bar 100A, 100B, then tapers back towards the centerline 110 to the upper portion 113 of the second side 102. Thus, the lower portion 117 includes a point on the outer periphery of the bar 100A, 100B that is located farthest from the centerline 110 definig a fourth distance d4. The upper portion 113 also has a point on the outer periphery of the bar 100A, 100B located farthest from the centerline 110 that defines a fifth distance between the centerline 110 and the outer periphery of the bar 100A, 100B. In accordance with aspects of the present invention, the fourth distance d4 is greater than the fifth distance d5.

The lower portion 117 of the second side 102 is similar to the lower portion 116 of the first side 101—the entire lower portion 116, 117 of the rotor bar 100 is nearly symmetrical about the centerline 110 in the embodiment illustrated in FIG. 2. In many embodiments of the invention, the respective points of the lower portion 116, 117 that are farthest from the centerline 110 are approximately equidistant from the centerline 110—distances d3 and d4 are approximately equal, though these distances may be varied depending on design considerations. Further, in the illustrated exemplary embodiment, the lower portion 116, 117 includes a bottom edge 120 that is oriented generally perpendicular to the centerline 110, and the centerline 110 approximately bisects the bottom edge 120. In other embodiments, the bottom edge 120 does not form a straight line, but rather, may form an arc or other shape.

In the exemplary rotor bar 100A shown in FIG. 2, the radius R of the rounded upper portion 112 is about twice the distance d2 from the outer edge 118 of the neck portion 114 to the centerline 110. In other words, the distance indicated by reference d2 in the particular embodiment illustrated in FIG. 2 is about 1/2R. The outer edge 118 of the neck portion 114 is generally parallel to the centerline 101. The lower portion 116 of the first side 101 tapers away from the centerline 110 and then tapers gradually back towards the centerline 110.

It is believed that the ratio of the length of the top and middle portions 112, 113, 114 to the total bar length is a key variable with respect to balancing starting and steady state motor performance. As the cross-section of the rotor bar is not symmetrical, the ratio of the upper and middle portions 112, 114 of the first side 101 to the total bar length is independent of the ratio of the top portion 113 of the second side 102 to the total bar length. These ratios may or may not be equal. Generally, a higher ratio will enhance starting performance and reduce break-down torque. In certain implementations, a ratio between 0.15 and 0.35 provides the best performance trade-offs. In the bars 100A, 100B illustrated in FIGS. 2 and 3, the ratio of the top and middle portions 112, 114 of the first side 101 to the total bar length is about the same as the ratio of the top portion 113 to the total bar length. The top portion 113 of the second side 102, for example, could be lengthened to increase the ratio, depending on the motor performance requirements.

As such, the eagle bars can have a larger area than that of double cage bars to get higher efficiency. By adjusting the geometry of the eagle bar head (thus reducing the surface flux density of rotor), eagle bars reduce stray losses thus improving the efficiency of motor. In various performance tests conducted on an induction motor employing the eagle bar shape as disclosed herein, the eagle bar provides torque per ampere at starting that is higher than a standard double-cage bar design, and much higher than single-cage bar designs. Steady state performance is equivalent or better, and breakdown torque is usually higher than double-cage bar shapes. Moreover, the eagle bar design offers lower surface flux density of the rotor, which leads to lower stray load losses for the motor.

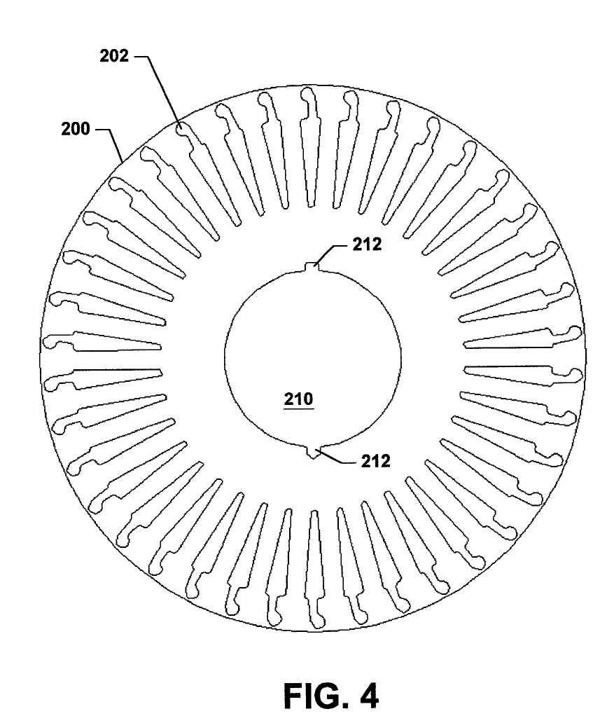

In a typical rotor construction, rotor laminations are assembled face-to-face with the slots aligned to form openings through which the rotor bars extend. FIG. 4 illustrates an exemplary lamination disk 200 having a plurality of circumferentially spaced closed slots 202 therein. The slots 202 define the distinctive eagle shape as disclosed herein. The slots 202 are oriented generally radially in the disk 200 such that, when a plurality of disks 202 are stacked face-to-face to form a rotor core, the slots 202 of the respective disks cooperate to form openings for receiving a rotor bar. As noted herein, the rotor bars may be cast in the openings, or may be externally formed and inserted into the openings formed by the slots 202.

In the lamination 200 shown in FIG. 4, the “heads” of the eagle slots 202 all face the same direction. The lamination 200 further includes an opening 210 in the center of the lamination for receiving a rotor shaft. The opening 210 further may include one or more a key ways 212. With a symmetrical bar cross-section, such as the prior art double-cage bar 10 shown in FIG. 1, the stacked laminations form the desired openings regardless of the orientation of the lamination faces. However, if the eagle-shaped slots 202 of the present invention are stamped in the lamination disk facing the same direction, as illustrated in FIG. 4, the laminations must be stacked with the proper faces together to prevent a mismatch of the slots. If even one lamination is flipped while building the lamination stack, the slots will not form the proper shape for the rotor bar.

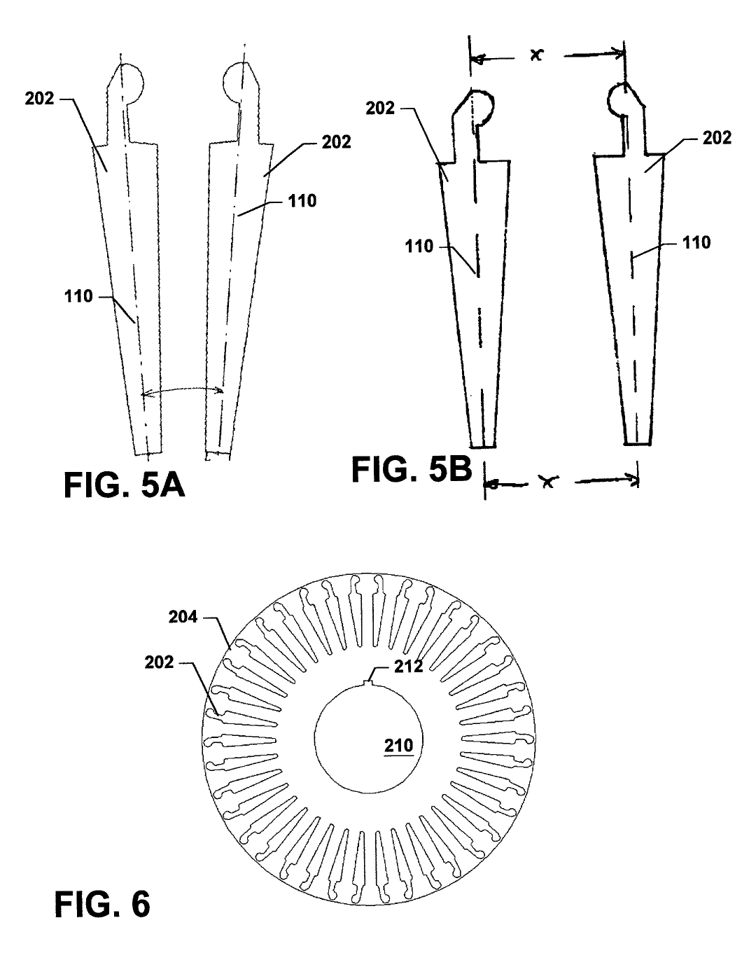

To simplify the manufacturing process, the symmetry of the lamination disks can be recovered by distributing the asymmetrical eagle slots in an alternating pattern as shown in FIGS. 5A and 5B and FIG. 6. FIG. 5A shows two rotor bar slots 202 facing in opposite directions, rather than facing the same direction as shown in the lamination 200 of FIG. 4. In FIG. 5A, the centerlines 110 for each of the slots 202 extend along a radius of the lamination disk 200. In FIG. 5B, the centerlines 110 are parallel. A lamination having slots 202 such as those shown in FIG. 5B would have the parallel pairs of slots 202 equally distributed about the lamination.

FIG. 6 illustrates a rotor lamination 204 similar to that illustrated in FIG. 4, except that adjacent eagle slots 202 face the opposite direction as shown in FIG. 5. The exemplary lamination 204 illustrated in FIG. 6 has slots 202 distributed radially about the lamination as shown in FIG. 5A. The alternating pattern of the eagle slots 202 allows the lamination stack to be constructed such that the slots form the desired bar opening shapes regardless of which way the individual lamination disks face. Such a symmetrical distribution of the slots greatly reduces manufacturing complexity and the associated costs.

Thus, the eagle bars of the present invention improve both starting and rated operation. Starting current may be reduced while maintaining the necessary starting torque. Or, starting torque may be increased while keeping the starting current unchanged. In other words, the disclosed eagle bars provide higher torque per amps value. Compromise can be made between starting torque and starting currents by adjusting the eagle bar dimensions depending on the design goal.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A rotor bar comprising:
a bar of electrically conductive material defining a cross sectional shape, the cross sectional shape being divided into first and second sides about a longitudinally extending centerline, the first and second sides being asymmetrical relative to the centerline;
the first longitudinal side having upper and lower portions connected by a middle portion, the upper, middle and lower portions each having a respective point on the outer periphery of the bar located farthest from the centerline defining first, second and third distances between the respective points and the centerline, wherein the second distance is less than either of the first and third distances; and
the second longitudinal side having an upper portion directly connected to a lower portion.

2. The rotor bar of claim 1, wherein the lower portions of the first and second longitudinal sides each define a bottom edge oriented generally perpendicular to the centerline, and wherein lengths of the bottom edge of the first side and the bottom edge of the second side are approximately equal.

3. The rotor bar of claim 1, wherein the lower portion of the second side has a point on the outer periphery of the bar located farthest from the centerline defining a fourth distance, and wherein the fourth distance is approximately equal to the third distance.

4. The rotor bar of claim 1, wherein the lower and upper portions of the second side each have a respective point on the outer periphery of the bar located farthest from the centerline defining fourth and fifth distances between the respective points and the centerline, and wherein the fourth distance is greater than the fifth distance.

5. The rotor bar of claim 1, wherein the ratio of the combined length of the upper and middle portions of the first side to the combined length of the upper, middle and lower portions of the first side is between about 0.15 to 0.35.

6. The rotor bar of claim 1, wherein the ratio of the length of the upper portion of the second side to the combined length of the upper and lower portions of the second side is between about 0.15 to 0.35.

7. The rotor bar of claim 1, wherein the ratio of the combined length of the upper and middle portions of the first side to the combined length of the upper, middle and lower portions of the first side is not equal to the ratio of the length of the upper portion of the second side to the combined length of the upper and lower portions of the second side.

8. The rotor bar of claim 1, wherein the upper portion of the first side includes a rounded portion defining a radius, wherein the radius is about twice the second distance.

9. The rotor bar of claim 1, wherein the middle portion includes an edge portion upon which the second point is located, and wherein the edge portion is generally parallel to the centerline.

10. A lamination for forming a rotor core for a rotating electrical machine, comprising:
a disk having a plurality of circumferentially spaced closed slots therein, the slots being oriented generally radially such that, when a plurality of the disks are stacked face to face to form the rotor core, the slots of the respective disks cooperate to form openings for receiving a bar of conductive material;
each slot defining a shape divided into first and second longitudinal sides about a radially-extending centerline;
the first longitudinal side having upper and lower portions connected by a middle portion, the upper, middle and lower portions each having a respective point on the outer periphery of the slot located farthest from the centerline defining first, second and third distances between the respective points and the centerline, wherein the second distance is less than either of the first and third distances; and
the second longitudinal side having an upper portion directly connected to a lower portion.

11. The lamination of claim 10, wherein each of the slots are oriented in the same direction.

12. The lamination of claim 10, wherein the plurality of slots are oriented in alternating directions.

13. The lamination of claim 10, wherein the lower portions of the first and second longitudinal sides each define a bottom edge oriented generally perpendicular to the centerline, and wherein lengths of the bottom edge of the first side and the bottom edge of the second side are approximately equal.

14. The lamination of claim 10, wherein the lower portion of the second side has a point on the outer periphery of the slot located farthest from the centerline defining a fourth distance, and wherein the fourth distance is approximately equal to the third distance.

15. The lamination of claim 10, wherein the lower and upper portions of the second side each have a point on the outer periphery of the slot located farthest from the centerline defining fourth and fifth distances between the respective points and the centerline, and wherein the fourth distance is greater than the fifth distance.

16. The lamination of claim 10, wherein the ratio of the combined length of the upper and middle portions of the first side to the combined length of the upper, middle and lower portions of the first side is between about 0.15 to 0.35.

17. The lamination of claim 10, wherein the ratio of the length of the upper portion of the second side to the combined length of the upper and lower portions of the second side is between about 0.15 to 0.35.

18. The lamination of claim 10, wherein the ratio of the combined length of the upper and middle portions of the first side to the combined length of the upper, middle and lower portions of the first side is not equal to the ratio of the length of the upper portion of the second side to the combined length of the upper and lower portions of the second side.

19. The lamination of claim 10, wherein the upper portion of the first side includes a rounded portion defining a radius, wherein the radius is about twice the second distance.

20. The lamination of claim 10, wherein the middle portion includes an edge portion upon which the second point is located, and wherein the edge portion is generally parallel to the centerline.

21. A rotor bar comprising:
a bar of electrically conductive material defining a cross sectional shape, the cross sectional shape being divided into first and second sides about a longitudinally extending centerline, the first and second sides being asymmetrical relative to the centerline;
the first longitudinal side having upper and lower portions connected by a middle portion, the upper, middle and lower portions of the first side each having a respective point on the outer periphery of the bar located farthest from the centerline defining first, second and third distances between the respective points and the centerline, wherein the second distance is less than either of the first and third distances; and
the second longitudinal side having an upper portion directly connected to a lower portion, the lower and upper portions of the second side each having a respective point on the outer periphery of the bar located farthest from the centerline defining fourth and fifth distances between the respective points and the centerline, wherein the fourth distance is greater than the fifth distance.

22. The rotor bar of claim 21, wherein the fourth distance is approximately equal to the third distance.

23. A lamination for forming a rotor core for a rotating electrical machine, comprising:
a disk having a plurality of circumferentially spaced closed slots therein, the slots being oriented generally radially such that, when a plurality of the disks are stacked face to face to form the rotor core, the slots of the respective disks cooperate to form openings for receiving a bar of conductive material;
each slot defining a shape divided into first and second longitudinal sides about a radially-extending centerline;
the first longitudinal side having upper and lower portions connected by a middle portion, the upper, middle and lower portions of the first side each having a respective point on the outer periphery of the slot located farthest from the centerline defining first, second and third distances between the respective points and the centerline, wherein the second distance is less than either of the first and third distances; and
the second longitudinal side having an upper portion directly connected to a lower portion, the lower and upper portions of the second side each having a respective point on the outer periphery of the bar located farthest from the centerline defining fourth and fifth distances between the respective points and the centerline, wherein the fourth distance is greater than the fifth distance.

24. The rotor bar of claim 23, wherein the fourth distance is approximately equal to the third distance.
